(19) United States
(12) Patent Application Publication
(10) Pub. No.: US 2012/0062535 A1
(43) Pub. Date: Mar. 15, 2012

(54) DRIVING METHOD OF ELECTRO-OPTICAL DEVICE, ELECTRO-OPTICAL DEVICE, AND ELECTRONIC APPARATUS

(75) Inventor: Hiroyuki Hara, Chino-shi (JP)

(73) Assignee: SEIKO EPSON CORPORATION, Tokyo (JP)

(21) Appl. No.: 13/321,761

(22) PCT Filed: Mar. 11, 2010
(86) PCT No.: PCT/JP2010/001755

§ 371 Date: Nov. 21, 2011

(30) Foreign Application Priority Data
May 25, 2009 (JP) 2009-125002

(51) Int. Cl. G06F 3/038

(52) U.S. Cl. 345/209

(57) ABSTRACT

In an electro-optical device, a liquid crystal element can be driven more appropriately.

An electro-optical device 1 includes: a scanning line driving circuit 130 which, in a plurality of subfields sf1 to sf8 constituting a field, sequentially supplies scanning signals for causing selection transistors 116 to be in an ON state to a plurality of scanning lines 112 and selects a pixel 110 for each of the scanning lines 112; and a data line driving circuit 140 which writes a signal potential corresponding to an image to be displayed on a pixel electrode 118 of the pixel 110 selected by the scanning line driving circuit 130 via a plurality of data lines 114, in the writing of the signal potential, when it is assumed that a polarity of the signal potential with respect to a potential of an opposite electrode 119 is a writing polarity, reverses the writing polarity a plurality of times in the field, and writes the signal potential so that the writing polarities of the plurality of subfield periods constituting a given field are the reverse of the writing polarities of the plurality of subfields constituting the next field.

### TECHNICAL FIELD

The present invention relates to a technical field of a driving method of an electro-optical device using an electro-optical material such as liquid crystals, an electro-optical device, and an electronic apparatus.

### BACKGROUND ART

As an electro-optical material of which optical properties are changed by an electrical energy, liquid crystals are known. The transmittance of liquid crystals is changed according to an applied voltage. The change in the transmittance is obtained as the orientation state of liquid crystal molecules is changed according to the applied voltage. In addition, liquid crystals have a property of being less likely to return to the original orientation state when a DC voltage is applied over an extended period. Therefore, a liquid crystal display device which applies liquid crystals to a display device employs AC drive in which the polarity of a voltage applied to a liquid crystal element that is an electro-optical element is reversed.

In general, such a type of liquid crystal display device includes: a plurality of scanning lines; a plurality of data lines; and a plurality of pixels provided to correspond to the intersections of the scanning lines and the data lines, in which the plurality of pixels each has a liquid crystal element including a pixel electrode, an opposite electrode, and liquid crystals interposed between the pixel electrode and the opposite electrode. In addition, as a technique of reversing a voltage applied to the liquid crystal element, a technique of fixing the potential of the opposite electrode (hereinafter, referred to as an opposite electrode potential) and reversing the polarity of a data potential supplied via the data line with respect to the opposite electrode potential is known.

In particular, in Patent Literature 1 and the like, when gradation display is performed in this type of liquid crystal display device, instead of a voltage modulation method, a technique of dividing a single field into a plurality of subfields, applying an ON or OFF voltage to a pixel (liquid crystal element) in each subfield to change a ratio of time for which the ON voltage (or OFF voltage) is applied to the pixel in the single field, thereby performing gradation display, that is, a technique of performing gradation display using a so-called digital time-division drive is disclosed.

Moreover, in Patent Literature 2 and the like, in a liquid crystal display device using this type of subfields, a technique of performing gradation display while weighting subfield periods is disclosed. According to this technique, it is known that by actively using transient response characteristics of liquid crystals, more gradation levels can be expressed with a smaller number of subfields.

### Citation List

### Patent Literature

[Patent Literature 1] JP-A-2003-114661

[Patent Literature 2] JP-A-2008-207063

### SUMMARY OF INVENTION

### Technical Problem

However, in Patent Literature 1, Patent Literature 2, and the like described above, a DC component is generated when the voltage applied to the liquid crystal element is reversed a plurality of times in units of the subfield periods in a single field period, so that there is a technical problem in which there is a possibility burn-in of a display screen occurring.

In order to solve the above-mentioned problems, for example, an object of the invention is to provide a driving method of an electro-optical device capable of driving liquid crystal elements more appropriately, an electro-optical device, and an electronic apparatus.

### Solution to Problem

In order to accomplish the object, a driving method of an electro-optical device which includes a plurality of scanning lines, a plurality of data lines, a plurality of pixels provided to correspond to intersections of the scanning lines and the data lines, in which the plurality of pixels each has an electro-optical element including a pixel electrode, an opposite electrode, and an electro-optical material interposed between the pixel electrode and the opposite electrode and a switching element which is provided between the pixel electrode and the data line and is controlled to be in any one of states including an ON state and an OFF state by a scanning signal supplied via the scanning line, includes: causing a period needed for displaying a single screen to be a field period, when the field period is constituted by a plurality of subfield periods, sequentially supplying the scanning signals for causing the switching elements to be in the ON state to the plurality of scanning lines for each of the plurality of subfield periods, selecting the pixel for each of the scanning lines, and writing a signal potential corresponding to an image to be displayed on the pixel electrode of the selected pixel; and in the writing of the signal potential, when it is assumed that a polarity of the signal potential with respect to a potential of the opposite electrode or a potential that is deviated from the potential of the opposite electrode by a predetermined potential is a writing polarity, reversing the writing polarity a plurality of times during the field period, and writing the signal potential so that the writing polarities of the plurality of subfield periods constituting a given field period are the reverse of the writing polarities of the plurality of subfields constituting the next field period.

In subfield drive, ON of OFF is designated to each of the plurality of subfields constituting a field according to the display gradation. Therefore, a positive polarity voltage application time and a negative polarity voltage application time cannot be caused to be equal to each other only by simply reversing the polarities of the signal potential applied to the electro-optical device in the fields. For this, in the invention, the signal potential is written so that the writing polarities of the plurality of subfields constituting a given field period are the reverse of the writing polarities of the plurality of subfields constituting the next field period, and therefore DC components caused by any one of the polarities can be substantially or completely removed from the voltage applied to the electro-optical element. As a result, according to the invention, deterioration of the electro-optical element due to the DC components can be substantially or completely eliminated. In addition, since the writing polarities are reversed a plurality of times in a field, flicker can also be suppressed. Moreover, the electro-optical element corresponds to, for example, a liquid crystal element.

In addition, it is preferable that the predetermined potential be set so as to compensate for a pushdown in which the potential of a drain is reduced during a change in the state from ON to OFF due to a parasitic capacitance between gate and drain electrodes of a transistor constituting the switching element. Therefore, the amplitude center of the signal potential may be aligned with the potential of the opposite electrode and may also be deviated therefrom.

In a more specific driving method, it is preferable that when it is assumed that X is a natural number equal to or greater than 2 and Y is an even number, the field period be constituted by an X·Y number of subfields, and the signal potential be written so that the reversal of the writing polarities is performed Y times for every X subfields during the field period (for example, corresponding to a first embodiment).

In this case, since the polarity reversal is performed Y times, that is, an even number of times in a field, the writing polarities of the plurality of subfield periods constituting a given field period are the reverse of the writing polarities of the plurality of subfields constituting the next field period. Here, when X subfield periods are a group, the reversal of the writing polarities is performed in units of a group. Here, in terms of suppression of flicker, it is preferable that the lengths of the groups be the same.

In addition, in another specific driving method, it is preferable that the field period be constituted by an even number of subfield periods, and the signal potential be written so that the reversal of the writing polarities is performed for every subfield period. In this case, application of DC component to the electro-optical element is prevented, and since the polarity reversal is performed in units of subfields, flicker can be significantly reduced.

In addition, in another specific driving method, when it is assumed that X is a natural number equal to or greater than 2 and Y is an odd number, the field period is constituted by an X·Y+2 number of subfield periods, and the signal potential is written so that the writing polarities of a first subfield period in the field period and a last subfield period are caused to be the same, and the reversal of the writing polarities is performed Y times for every X subfield periods in an X·Y number of subfield periods from the first to immediately before the last. In this case, that the same polarity is continuous over fields can be completely eliminated, so that the number of polarity reversals in two continuous fields can be increased, thereby more efficiently reducing the generation of flicker on the screen.

In addition, the driving method of an electro-optical device described above can be understood as the invention of an electro-optical device or an electronic apparatus which employs the driving method as follows.

An electro-optical device according to the invention includes: a plurality of scanning lines; a plurality of data lines; a plurality of pixels provided to correspond to intersections of the scanning lines and the data lines, the plurality of pixels each having an electro-optical element including a pixel electrode, an opposite electrode, and an electro-optical material interposed between the pixel electrode and the opposite electrode and a switching element which is provided between the pixel electrode and the data line and is controlled to be in any one of states including an ON state and an OFF state by a scanning signal supplied via the scanning line; scanning line driving means for causing a period needed for displaying a single screen to be a field period, when the field period is constituted by a plurality of subfield periods, sequentially supplying the scanning signals for causing the switching elements to be in the ON state to the plurality of scanning lines for each of the plurality of subfield periods, and selecting the pixel for each of the scanning lines; and data line driving means for writing a signal potential corresponding to an image to be displayed on the pixel electrode of the pixel selected by the scanning line driving means via the plurality of data lines, and in the writing of the signal potential, when it is assumed that a polarity of the signal potential with respect to a potential of the opposite electrode or a potential that is deviated from the potential of the opposite electrode by a predetermined potential is a writing polarity, reversing the writing polarity a plurality of times during the field period, and writing the signal potential so that the writing polarities of the plurality of subfield periods constituting a given field period are the reverse of the writing polarities of the plurality of subfields constituting the next field period.

In a specific form of the electro-optical device, it is preferable that when it is assumed that X is a natural number equal to or greater than 2 and Y is an even number, the field period be constituted by an X·Y number of subfields, and the data line driving means write the signal potential so that the reversal of the writing polarities is performed Y times for every X subfields during the field period.

In addition, the field period may be constituted by an even number of subfield periods, and the data line driving means may write the signal potential so that the reversal of the writing polarities is performed for every subfield period.

Moreover, when it is assumed that X is a natural number equal to or greater than 2 and Y is an odd number, the field period may be constituted by an X·Y+2 number of subfield periods, and the data line driving means may write the signal potential so that the writing polarities of a first subfield period in the field period and a last subfield period are caused to be the same, and the reversal of the writing polarities is performed Y times for every X subfield periods in an X·Y number of subfield periods from the first to immediately before the last.

In addition, an electronic apparatus according to the invention includes the electro-optical device described above. The electronic apparatus corresponds to a display, a computer, a portable phone, a portable information terminal, or the like.

### BRIEF DESCRIPTION OF DRAWINGS

FIG. 1 is a block diagram showing the entire configuration of an electro-optical device 1 according to a first embodiment.

FIG. 2 is a diagram showing a detailed configuration of a pixel 110 according to the first embodiment, and is a schematic diagram showing the configuration of a total of 4 pixels of a 2×2 matrix corresponding to the intersections of an i-th row, and an (i+1)-th row adjacent to this, a j-th column, and a (j+1)-th column adjacent to this.

FIG. 3 is a schematic diagram showing the configuration of subfields in the electro-optical device according to the first embodiment.

FIG. 4 is a table showing ON and OFF conversion of the subfields in the electro-optical device according to the first embodiment.

FIG. 5 is a graph showing gradation characteristics by the electro-optical device according to the first embodiment.

FIG. 6 is a schematic diagram showing a change in a voltage P(i,j) of a pixel electrode 118 in a liquid crystal element 120 in the i-th row and the j-th column according to the first embodiment.

FIG. 7 is a schematic diagram showing polarities in the subfields according to the first embodiment, and a progress of selection of 1-st to 2160-th rows of scanning lines.

FIG. 8 is a schematic diagram showing a change in the voltage P(i,j) of the pixel electrode 118 in the liquid crystal element 120 in the i-th row and the j-th column according to a first comparative example.

FIG. 9 is a schematic diagram showing polarities in the subfields according to the first comparative example, and a progress of selection of the 1-st to 2160-th rows of the scanning lines.

FIG. 10 is a table showing the degree of burn-in in this embodiment and the degree of burn-in in the first comparative example in units of gradation levels.

FIG. 11 is a schematic diagram showing a change in the voltage P(i,j) of the pixel electrode 118 in the liquid crystal element 120 in the i-th row and the j-th column according to a second embodiment.

FIG. 12 is a schematic diagram showing polarities in the subfields according to the second embodiment, and a progress of selection of the 1-st to 2160-th rows of the scanning lines.

FIG. 13 is a schematic diagram showing a change in the voltage P(i,j) of the pixel electrode 118 in the liquid crystal element 120 in the i-th row and the j-th column according to a second comparative example.

FIG. 14 is a schematic diagram showing polarities in the subfields according to the second comparative example, and a progress of selection of the 1-st to 2160-th rows of the scanning lines.

FIG. 15 is a schematic diagram showing a change in the voltage P(i,j) of the pixel electrode 118 in the liquid crystal element 120 in the i-th row and the j-th column according to a third embodiment.

FIG. 16 is a schematic diagram showing polarities in the subfields according to the third embodiment, and a progress of selection of the 1-st to 2160-th rows of the scanning lines.

FIG. 17 is a perspective view showing the configuration of a personal computer which is an example of an electronic apparatus to which the electro-optical device according to this embodiment is applied.

FIG. 18 is a perspective view showing the configuration of a portable phone which is an example of the electronic apparatus to which the electro-optical device according to this embodiment is applied.

FIG. 19 is a perspective view showing the configuration of a portable information terminal which is an example of the electronic apparatus to which the electro-optical device according to this embodiment is applied.

### DESCRIPTION OF EMBODIMENTS

Hereinafter, exemplary embodiments of the invention will be described with reference to the drawings.

### First Embodiment

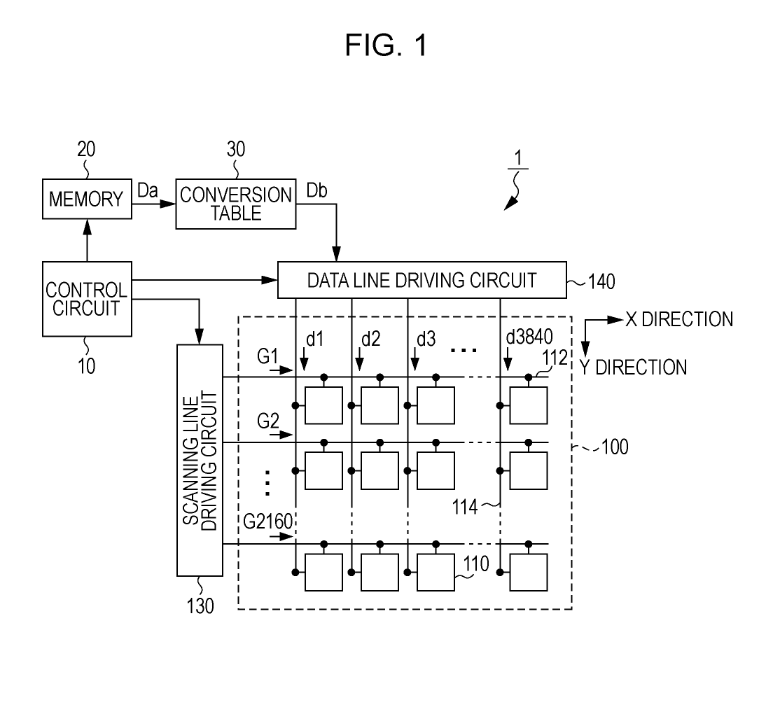

First, a first embodiment of the invention will be described. FIG. 1 is a block diagram showing the entire configuration of an electro-optical device 1 according to the first embodiment.

As shown in FIG. 1, the electro-optical device 1 is roughly divided into a control circuit 10, a memory 20, a conversion table 30, a display area 100, a scanning line driving circuit 130, and a data line driving circuit 140. Among them, the control circuit 10 controls each part as described later.

In the display area 100, pixels are arranged in a matrix form. Specifically, in the display area 100, 2160 rows of scanning lines (writing scanning lines) 112 extend in the horizontal X direction in the figure, and 3840 columns of data lines 114 extend in the vertical Y direction in the figure while maintaining electrical insulation from the scanning lines 112. In addition, pixels 110 are provided to respectively correspond to the intersections of the scanning lines 112 and the data lines 114. Therefore, in this embodiment, the pixels 110 are arranged in a matrix form having vertical 2160 rows×horizontal 3840 columns; however, the invention is not intended to be limited to this arrangement.

The memory 20 has storage areas corresponding to the pixels arranged in the vertical 2160 rows×horizontal 3840 columns, and each storage area stores display data Da of the corresponding pixel 110. The display data Da designates brightness (gradation level) of the pixel 110, and in this embodiment, the brightness is designated in 16 stages from “0” to “15” in units of “1”. Here, the gradation level “0” designates black as the lowest gradation, and since the brightness is increased as the gradation level is increased, the gradation level “15” designates white as the highest gradation.

In addition, the display data Da is supplied from a high-order device (not shown), and is stored in the storage area corresponding to the pixel by the control circuit 10, and one corresponding to a scanned pixel in the display area 100 is read from the memory 20.

The conversion table 30 converts the display data Da read from the memory 20 into data Db designating whether an ON or OFF voltage is applied to the pixel 110 (liquid crystal element) according to the gradation level and the subfield designated for the corresponding display data Da. In addition, the conversion contents will be described later.

### <Configuration of Pixel>

For convenience of description, the configuration of the pixel 100 will be described with reference to FIG. 2. FIG. 2 is a diagram showing a detailed configuration of the pixel 110 according to the first embodiment, and is a schematic diagram showing the configuration of a total of 4 pixels of a 2×2 matrix corresponding to the intersections of an i-th row, and an (i+1)-th row adjacent to this, a j-th column, and a (j+1)-th column adjacent to this. Here, i and (i+1) are symbols for generally indicating rows in which the pixels 110 are arranged, and in this embodiment, are integers equal to or greater than 1 and equal to or less than 2160, while j and (j+1) are symbols for generally indicating columns in which the pixels 110 are arranged, and in this embodiment, are integers equal to or greater than 1 and equal to or less than 3840.

As shown in FIG. 2, each pixel 110 includes an re-channel type transistor (MOS-type FET) 116 and a liquid crystal element 120.

Here, since the pixels 110 have the same configuration, one that is positioned in the i-th row and the j-th column is representatively described. A gate electrode of the transistor in the pixel 110 in the i-th row and the j-th column is connected to the scanning line 112 in the i-th row, a source electrode thereof is connected to the data line 114 in the j-th column, and a drain electrode thereof is connected to the pixel electrode 118 which is one end of the liquid crystal element 120. In addition, the other end of the liquid crystal element 120 is an opposite electrode 108. The opposite electrode 108 is common to all the pixels 110, and in this embodiment, is maintained at a voltage LCcom.

The display area 100 has a configuration in which an element substrate having the scanning line 112, the data line 114, a transistor 116, the pixel electrode 118, and the like which are formed therein and an opposite substrate having the opposite electrode 108 formed are maintained at a predetermined gap (interval) and are bonded to each other so as to cause the electrode formation surfaces to oppose each other, and liquid crystals 105 are sealed in the gap (not shown). Therefore, the liquid crystal element 120 in this embodiment has a configuration in which the pixel electrode 118 and the opposite electrode 108 interpose the liquid crystals 105 therebetween.

Moreover, in this embodiment, an LCOS (Liquid Crystal on Silicon) type in which a semiconductor substrate is used as the element substrate, a transparent substrate such as glass is used as the opposite substrate, and the liquid crystal element 120 is of a reflective type is used. Therefore, a configuration in which as well as the scanning line driving circuit 130 and the data line driving circuit 140, the control circuit 10, the memory 20, and the conversion table 30 are also formed in the element substrate may be used.

In this configuration, when a selection voltage (scanning signal) is applied to the scanning line 112 to turn on (conduction) the transistor 116 (switching element), and a data signal is supplied to the pixel electrode 118 via the data line 114 and the transistor 116 in the ON state, in the liquid crystal element 120 corresponding to the intersection of the scanning line 112 to which the selection voltage is applied and the data line 114 to which the data signal is supplied, a voltage difference between the voltage of the data signal and the voltage LCcom applied to the opposite electrode 108 is written. In addition, when the scanning line 112 is at a non-selection voltage, although the transistor 116 enters an OFF (non-conduction) state, in the liquid crystal element 120, the voltage written when the transistor 116 is in the conduction state is held by the capacitance.

In this embodiment, the liquid crystal element 120 is set in a normally black mode. Therefore, the reflectance (the transmittance in the case of a transmissive type) of the liquid crystal element 120 becomes dark as the effective value of the voltage difference between the pixel electrode 118 and the opposite electrode 108 is reduced, and becomes almost black in a state where a voltage is not applied. However, in this embodiment, to the pixel electrode 118, any one of the ON voltage to cause the voltage difference to be equal to or higher than the saturation voltage and the OFF voltage that is equal to or lower than a threshold voltage is applied.

In the normally black mode, assuming that the reflectance in the darkest state is a relative reflectance of 0% and the reflectance in the brightest state is a relative reflectance of 100%, from among voltages applied to the liquid crystal element 120, a voltage that causes a relative reflectance to be 10% is an optical threshold voltage, and a voltage that causes a relative reflectance to be 90% is an optical saturation voltage. In the voltage modulation method (analog drive), when the liquid crystal element 120 is caused to have a half tone (gray), it is designed that a voltage equal to or lower than the optical saturation voltage is applied to the liquid crystals 105. Therefore, the reflectance of the liquid crystals 105 has a value almost in proportion to the applied voltage.

For this, in this embodiment, as the voltages applied to the liquid crystal element 120, gradation display is performed using only two voltages including the ON voltage and the OFF voltage. Specifically, the gradation display in this embodiment is executed by dividing a single field into a plurality of subfields, and allocating periods in which the ON or OFF voltage is applied to the liquid crystal element 120 in units of subfields.

In this embodiment, as a voltage used as the ON voltage, a voltage of about 1 to 1.5 times the saturation voltage is used. This is because this is preferable in order to improve response characteristics of liquid crystals since a rise with regard to the response characteristics of liquid crystals is in a proportionate relationship to a voltage level applied to the liquid crystal element.

In addition, as a voltage used as the OFF voltage, a voltage equal to or lower than the optical threshold voltage of the liquid crystal element 120 is used.

In addition, the actual reflectance of the liquid crystal element is a response of liquid crystals and thus is in proportion to an integral of a period in which the ON voltage is applied; however, for simplifying description, there may be cases where it is described that the reflectance is in proportion to the period in which the ON voltage is applied.

### <Subfield Configuration>

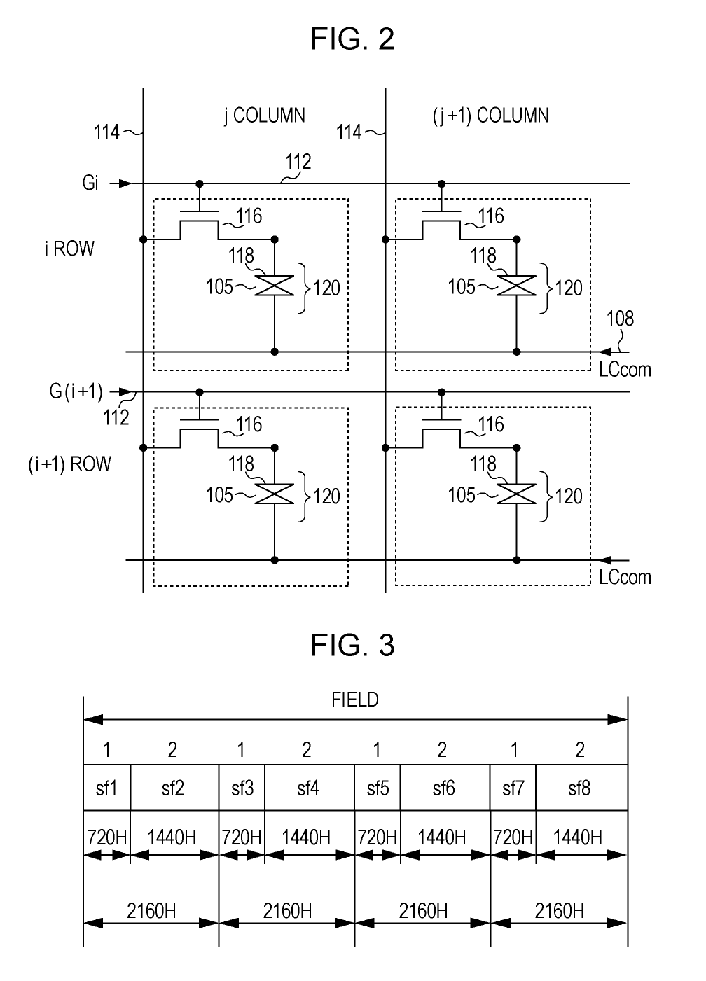

There, first, the configuration of subfields in this embodiment will be described with reference to FIG. 3. Here, FIG. 3 is a schematic diagram showing the configuration of subfields in the electro-optical device according to the first embodiment.

In FIG. 3, a single field is referred to as a period needed for forming an image for a sheet, has the same meaning as a frame in a non-interlace type, and is constant at 16.7 miliseconds (a frequency of 60 Hz).

As shown in FIG. 3, in this embodiment, a single field period is equally divided into 4 groups, and each of the groups is divided into 2 subfields. Therefore, the single field is divided into a total of 8 subfields; however, for convenience, the subfields are sequentially called sf1, sf2, sf3, . . . , sf8 from the first of the single field.

Here, when a cycle of a clock signal Cly which is described later is denoted by 1 H, the period length of a single group is 2160 H, and therefore, the period length of the single field becomes 8640(=2160×4) H.

In addition, the period lengths of the odd number subfields sf1, sf3, sf5, and sf7 are each set to 720 H, and the period lengths of the even number subfields sf2, sf4, sf6, and sf8 are each set to 1440 H. Therefore, assuming that the ratio of the period lengths of the odd number subfields sf1, sf3, sf5, and sf7 is “1”, the ratio of the period lengths of the even number subfields sf2, sf4, sf6, and sf8 becomes “2”, so that the ratio of the period length of the single field becomes “12”.

In addition, the fields are continuous in terms of time, so that the subfield sf8 of a given field is adjacent to the subfield sf1 of the next field.

### <Conversion Contents of Conversion Table>

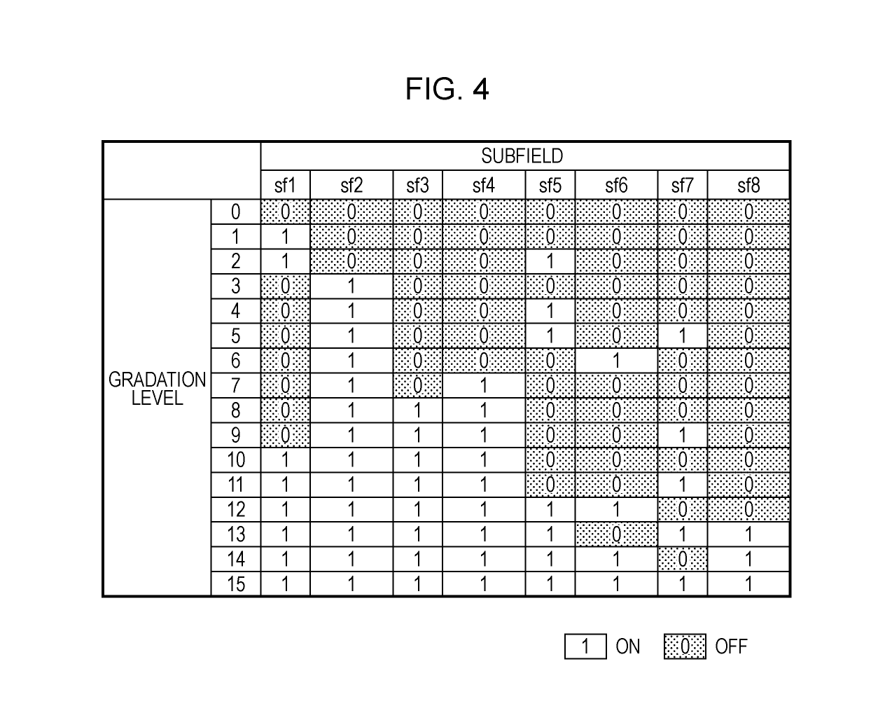

Next, the conversion contents of the conversion table 30 for actually performing the gradation display will be described with reference to FIG. 4. The conversion table 30 stores gradation levels to be displayed and SF codes to correspond to each other. The SF codes designate any one of the ON voltage and the OFF voltage to the liquid crystal element 120 for each of the subfields sf1 to sf8. Accordingly, the display data Da read from the memory 20 is converted into the data Db designating whether the ON or OFF voltage is applied to the liquid crystal element 120 for each of the subfields sf1 to sf8.

In this figure, “1” designates that the ON voltage is applied to the liquid crystal element 120, and “0” designates that the OFF voltage is applied to the liquid crystal element 120. For example, when the gradation level is “5”, it is designated that the ON voltage is applied to the liquid crystal element 120 for the subfields sf2, sf5, and sf7, and the OFF voltage is applied to other subfields. In this embodiment, in consideration of the response characteristics of liquid crystals, correspondence between the gradation levels and the SF codes are determined.

Moreover, it is generally known that human visual characteristics have exponential or logarithmic characteristics. Therefore, even though the gradation level is linearly changed, the human eye does not feel that the gradation level is linearly changed. In addition, in a display element such as a liquid crystal element or an organic EL element (Electronic Luminescence), even though a voltage or the like is linearly changed, the change in actual brightness of the display element becomes curved.

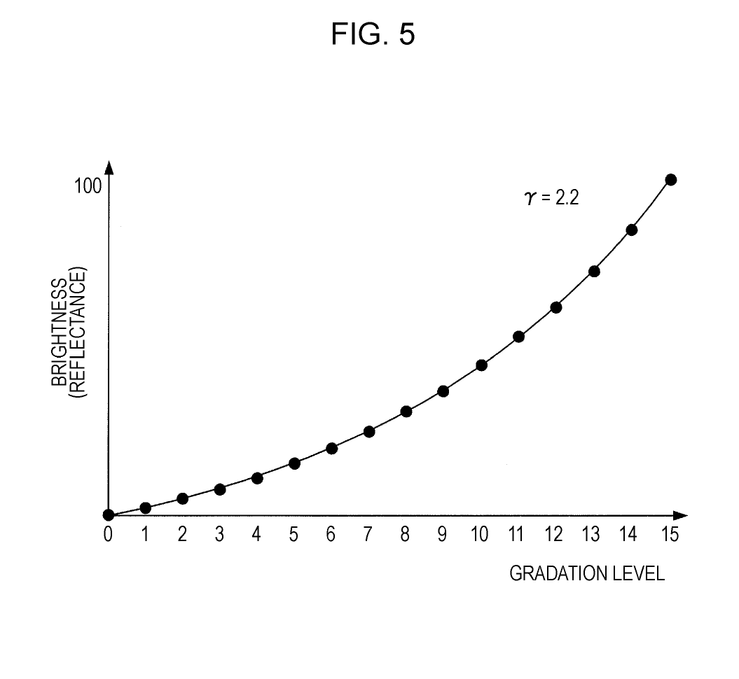

For this reason, in a display device, for a gradation level designating the gradation of a pixel, converting the brightness of a display element to curved characteristics (γ characteristics) in consideration of the human visual characteristics is generally performed. When the gradation is expressed according to such γ characteristics, a gradation change is linearly shown by the human eye. Here, a γ factor in the γ characteristics is ideally set to “2.2” when a liquid crystal element is used as the display element. In this embodiment, conversion characteristics are set so that when the display data Da is converted into the data Db according to the above-mentioned conversion table 30, gradation level and brightness shown in FIG. 5 are obtained.

### <Scanning Line Driving Circuit>

Next, the scanning line driving circuit 130 generates scanning signals G1, G2, . . . , G2160 which become sequentially and exclusively effective for each of the subfields sf1 to sf8. Accordingly, 1, 2, 3, 4, . . . , 2159, 2160-th rows of the scanning lines are sequentially selected. When the scanning signals G1, G2, . . . , G2160 become sequentially effective, the transistors 116 of the pixels 110 in the 1, 2, 3, 4, . . . , 2159, 2160-th rows sequentially enter the ON state. The plurality of pixels 110 are selected as such in units of rows, and the data signals (signal potentials) are written in the pixel electrodes 118 via the data lines 114. In addition, a period corresponding to a subfield in a pixel in each row is a period taken after a scanning line is selected and an ON or OFF voltage is written, until the scanning line is selected again.

### <Data Line Driving Circuit>

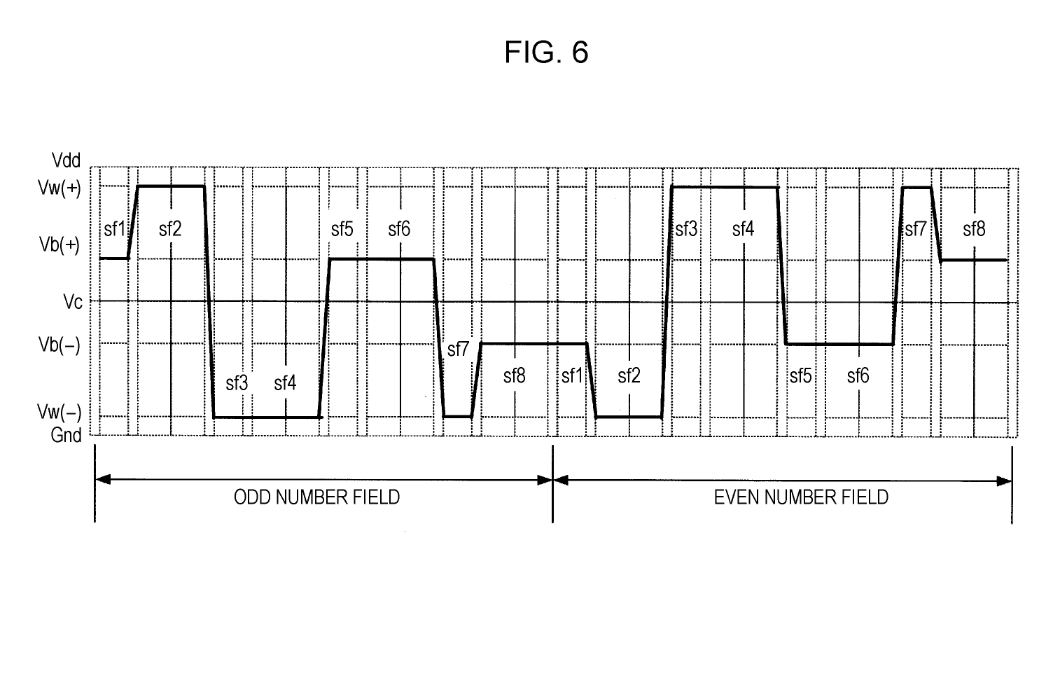

Subsequently, in addition to FIG. 6, appropriately referring to FIG. 1 described above, the data line driving circuit 140 related to this embodiment will be described. Here, FIG. 6 is a schematic diagram showing a change in a voltage P(i,j) of the pixel electrode 118 in the liquid crystal element 120 in the i-th row and the j-th column according to the first embodiment. In addition, in FIG. 6, as the gradation level, a gradation level of “9” is designated.

The data line driving circuit 140 converts the data Db converted by the conversion table 30 into a voltage with a polarity designated by the control circuit 10, so as to be supplied to the data line 114 in the row corresponding to the data Db as a data signal. Specifically, in a case where the data Db converted by the conversion table 30 is “1” representing application of the ON voltage to the liquid crystal element 120, the data line driving circuit 140 converts the data Db to a voltage Vw(+) when positive polarity writing is designated by the control circuit 10 and converts the data Db to a voltage Vw(−) when negative polarity writing is designated. In a case where the data Db is “0” representing application of the OFF voltage to the liquid crystal element 120, the data line driving circuit 140 converts the data Db to a voltage Vb(+) when the positive polarity writing is designated and converts the data Db to a voltage Vb(−) when the negative polarity writing is designated.

In addition, the data signals supplied to the 1, 2, 3, . . . , 3840-th data lines 114 are denoted by d1, d2, d3, . . . , d3840, and the data signal in the j-th column when a column is not specified is denoted by dj.

The voltages Vw(+) and Vw(−) are voltages for applying the ON voltage to the liquid crystal element 120, and as shown in FIG. 6, are in a symmetric positional relationship with respect to a voltage Vc. As described above, in this embodiment, since the voltage LCcom is applied to the opposite electrode 108, when the voltage Vw(+) is applied to the pixel electrode 118, a voltage difference between the voltage Vw(+) and the voltage LCcom is applied to the liquid crystal element 120 as the ON voltage, and when the voltage Vw(−) is applied to the pixel electrode 118, a voltage difference between the voltage Vw(−) and the voltage LCcom is applied to the liquid crystal element 120 as the ON voltage.

In addition, as the ON voltage, as described above, a voltage of 1 to 1.5 times the saturation voltage is used. However, in the case where the voltages Vw(+) and Vw(−) are applied to the pixel electrode 118, a saturation response time taken until the reflectance of the liquid crystal element 120 is saturated and becomes white may be longer than the period length of the shortest subfield sf1. In other words, the period length of the subfield sf1 may be shorter than the saturation response time of the liquid crystal element 120.

On the other hand, the voltages Vb(+) and Vb(−) are voltage for applying the OFF voltage of the liquid crystal element 120, and as shown in FIG. 6, are in a symmetric positional relationship with respect to the voltage Vc. When the voltage Vb(+) is applied to the pixel electrode 118, a voltage difference between the voltage Vb(+) and the voltage LCcom is applied to the liquid crystal element as the OFF voltage, and when the voltage Vb(−) is applied to the pixel electrode 118, a voltage difference between the Vb(−) and the voltage LCcom is applied to the liquid crystal element as the OFF voltage.

Here, when a DC component is applied to the liquid crystal element 120, the liquid crystals 105 are deteriorated, so that voltages on a high-order side and a low-order side with respect to the reference voltage Vc are alternately applied to the pixel electrode 118 (AC drive). In the AC drive, whether the voltage applied to the pixel electrode 118, that is, a voltage of a data signal is the high-order side voltage or the low-order side voltage with respect to the reference voltage Vc is a writing polarity, and the case of the high-order side is a positive polarity and the case of the low-order side is a negative polarity. In addition, polarity reversal control for switching any one of the positive polarity writing and the negative polarity writing according to this embodiment to the other one will be described later.

Therefore, the voltages Vw(+) and Vb(+) are positive polarity voltages, and the voltages Vw(−) and Vb(−) are negative polarity voltages. In addition, the writing polarity in this embodiment uses the voltage Vc as a reference; however, with regard to the voltage, if not particularly described, a ground potential Gnd corresponding to an L level of logic levels is the reference of a voltage of zero.

However, the voltage LCcom applied to the opposite electrode 108 is set to a slightly lower order side than the reference voltage Vc. This is because in the n-channel type transistor 116, due to a parasitic capacitance between the gate and drain electrodes, a pushdown (also called field-through or penetration) in which the potential of the drain (the pixel electrode 118) is reduced during a change in the state from ON to OFF occurs. If the voltage LCcom is equal to the reference voltage Vc, the voltage effective value of the liquid crystal element 120 by the negative polarity writing becomes slightly greater than the voltage effective value by the positive polarity writing due to the pushdown (when the transistor 116 is of the n-channel type). Therefore, the voltage LCcom is offset to an appropriate value for cancelling the effect of the pushdown on the lower-order side than the reference voltage Vc. Here, if the effect of the pushdown can be ignored, the voltage LCcom and the reference voltage Vc are set to be equal to each other.

### <Polarity Reversal Control>

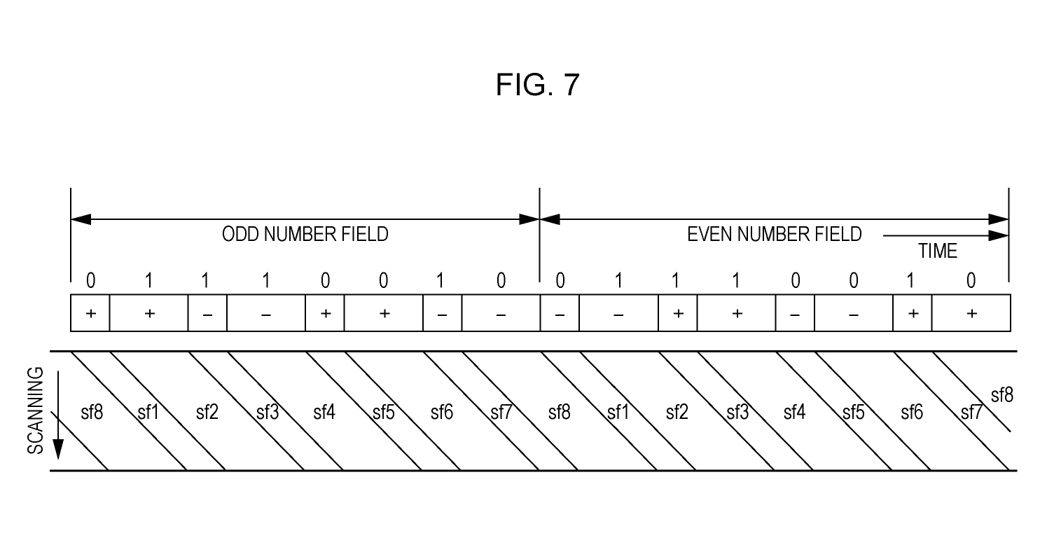

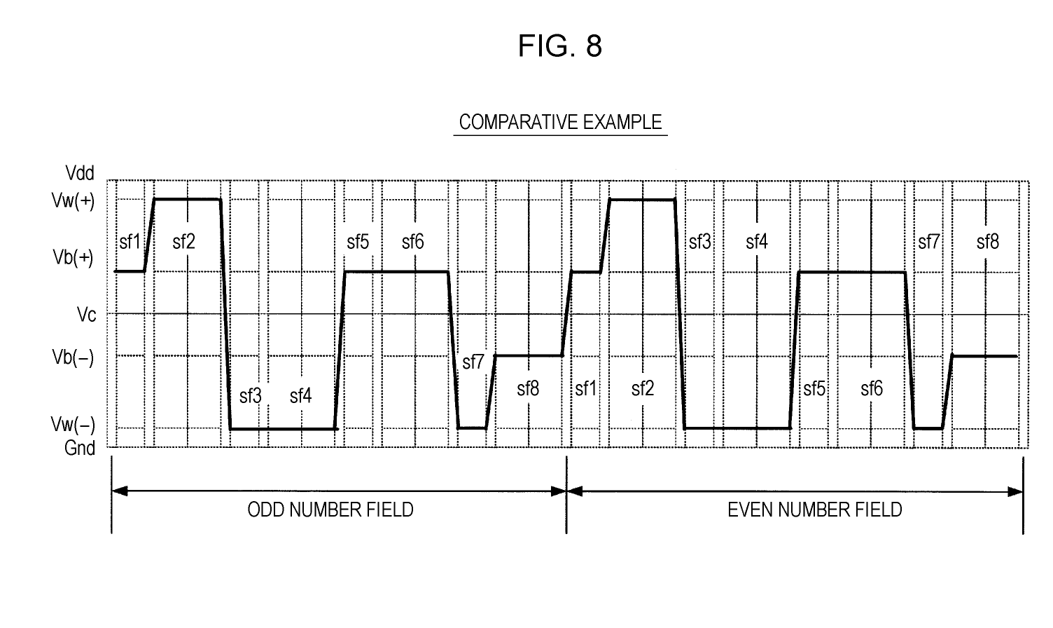

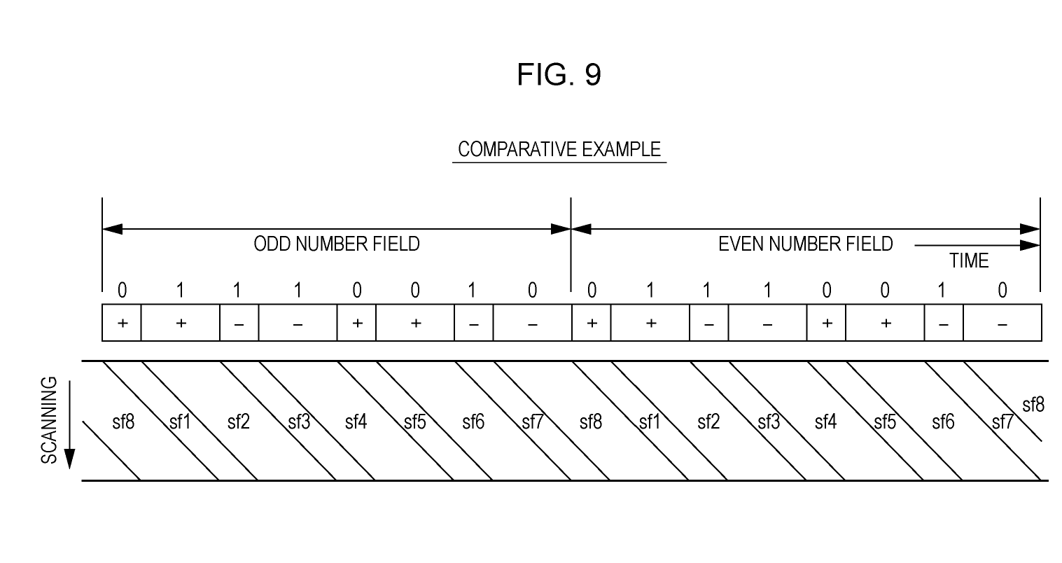

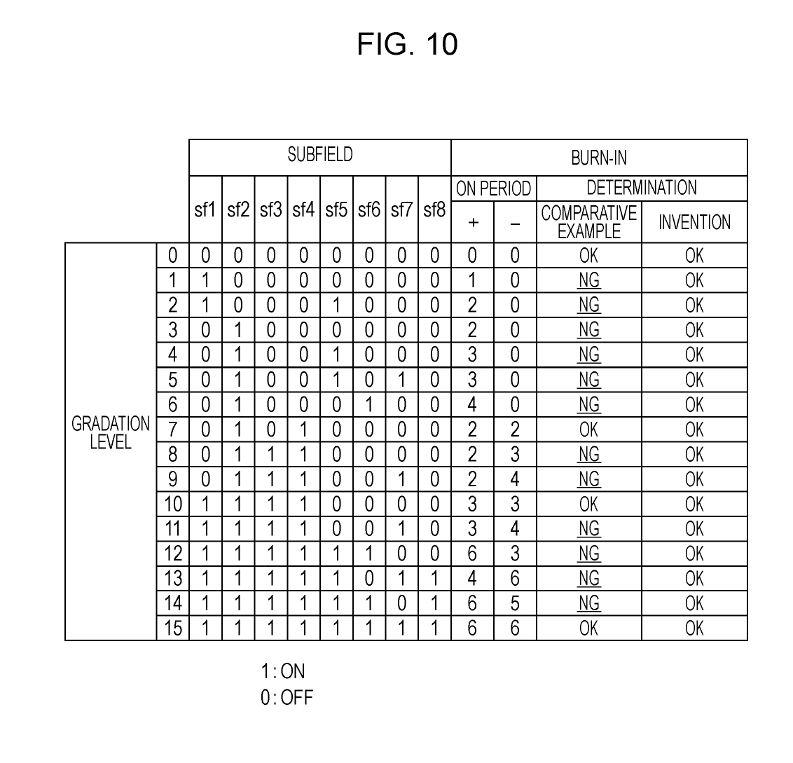

Next, in addition to FIGS. 7 to 10, appropriately referring to FIG. 6 described above, the polarity reversal control for switching any one of the positive polarity writing and the negative polarity writing according to this embodiment to the other one will be described. Here, FIG. 7 is a schematic diagram showing polarities of signal potentials in the subfields according to the first embodiment, and a progress of selection of the 1-st to 2160-th rows of the scanning lines. As described above, in FIGS. 6 and 7, as the gradation level, a gradation level “9” is designated. In addition, in FIG. 7, “+” means the positive polarity writing, and “−” means the negative polarity writing. FIG. 8 is a schematic diagram showing a change in the voltage P(i,j) of the pixel electrode 118 in the liquid crystal element 120 in the i-th row and the j-th column according to a first comparative example. FIG. 9 is a schematic diagram showing polarities in the subfields according to the first comparative example, and a progress of selection of the 1-st to 2160-th rows of the scanning lines. In FIGS. 8 and 9, as the gradation level, the gradation level “9” is also designated. FIG. 10 is a table showing the degree of burn-in in this embodiment and the degree of burn-in in the first comparative example in units of gradation levels.

As described above, if the positive polarity writing is designated, when a scanning signal Gi is at a H level, a voltage P(i,j) becomes any one of the voltage Vw(+) for applying the ON voltage to the liquid crystal element and the voltage Vb(+) for applying the OFF voltage thereto to be held for each subfield period. In addition, if the negative polarity writing is designated, when a scanning signal Gi is at the H level, a voltage P(i,j) becomes any one of the voltage Vw(−) for applying the ON voltage to the liquid crystal element and the voltage Vb(−) for applying the OFF voltage thereto to be held for each subfield period.

As shown in FIG. 6, when the gradation level “9” is designated, the ON voltages are applied in the subfields sf2 to sf4 and sf7, and the OFF voltages are applied in other subfields sf1, sf5, sf6, and sf8.

In addition, as shown in FIG. 7, in an odd number field, the subfields sf1 and sf2 designate the positive polarity writing, the subfields sf3 and sf4 designate the negative polarity writing, the subfields sf5 and sf6 designate the positive polarity writing, and the subfields sf7 and sf8 designate the negative polarity writing. On the other hand, in an even number field, the subfields sf1 and sf2 designate the negative polarity writing, the subfields sf3 and sf4 designate the positive polarity writing, the subfields sf5 and sf6 designate the negative polarity writing, and the subfields sf7 and sf8 designate the positive polarity writing.

Therefore, polarity reversal is executed a plurality of times (in this example, 4 times) on all the fields, and moreover, the data signal (signal potential) is written in the pixel 110 so that the wiring polarity of each of the plurality of subfields (sf1 to sf8) constituting the odd number field which is a given field is the reverse of the writing polarity of each of the plurality of subfields (sf1 to sf8) constituting the even number field which is the next field. That is, the writing polarity of the subfield sf1 of the even number field is the reverse of the writing polarity of the subfield sf1 of the odd number field, the writing polarity of the subfield sf2 of the even number field is the reverse of the writing polarity of the subfield sf2 of the odd number field, the writing polarity of the subfield sf3 of the even number field is the reverse of the writing polarity of the subfield sf3 of the odd number field, the writing polarity of the subfield sf4 of the even number field is the reverse of the writing polarity of the subfield sf4 of the odd number field, the writing polarity of the subfield sf5 of the even number field is the reverse of the writing polarity of the subfield sf5 of the odd number field, the writing polarity of the subfield sf6 of the even number field is the reverse of the writing polarity of the subfield sf6 of the odd number field, the writing polarity of the subfield sf7 of the even number field is the reverse of the writing polarity of the subfield sf7 of the odd number field, and the writing polarity of the subfield sf8 of the even number field is the reverse of the writing polarity of the subfield sf8 of the odd number field.

Accordingly, as shown in FIG. 6, in the odd number field, the voltage P(i,j) becomes the voltage Vw(+) over a period corresponding to the subfield sf2 to which the ON voltage is applied and the positive polarity writing is designated. On the other hand, to the subfield sf2 in the even number field, the ON voltage is applied and the negative polarity writing is designated, so that the voltage P(i,j) becomes the voltage Vw(−) over a period corresponding to the subfield sf2.

In addition, in the odd number field, the voltage P(i,j) becomes the voltage Vw(−) over a period corresponding to the subfields sf3, sf4, and sf7 to which the ON voltages are applied and the negative polarity writing is designated. On the other hand, to the subfields sf3, sf4, and sf7 in the even number field, the positive polarity writing is designated and the ON voltages are applied, so that the voltage P(i,j) becomes the voltage Vw(+) over the period corresponding to the subfields sf3, sf4, and sf7. Accordingly, in two continuous fields, in other words, in the odd number field and the even number field, a positive polarity voltage application time for which the ON voltage is applied with the positive polarity, and a negative polarity voltage application time for which the ON voltage is applied with the negative polarity become equal to each other, so that a DC component caused by the ON voltages can be substantially or completely removed from the voltage applied to the liquid crystal element 120.

In addition, in the odd number field, the voltage P(i,j) becomes the voltage Vb(+) for a period corresponding to the subfields sf1, sf5, and sf6 to which the OFF voltages are applied and the positive polarity writing is designated. On the other hand, in the even number field, since the OFF voltages are applied and the negative polarity writing is designated to the subfields sf1, sf5, and sf6, the voltage P(i,j) becomes the voltage Vb(−) over the period corresponding to the subfields sf1, sf5, and sf6.

In addition, in the odd number field, the voltage P(i,j) becomes the voltage Vb(−) for a period corresponding to the subfield sf8 to which the OFF voltage is applied and the negative polarity writing is designated. On the other hand, in the even number field, since the positive polarity writing is designated and the OFF voltage is applied to the subfield sf8, the voltage P(i,j) becomes the voltage Vb(+) over the period corresponding to the subfield sf8. Accordingly, in two continuous fields, in other words, in the odd number field and the even number field, a positive polarity voltage application time for which the OFF voltage is applied with the positive polarity, and a negative polarity voltage application time for which the OFF voltage is applied with the negative polarity become equal to each other, so that a DC component caused by the OFF voltages can be substantially or completely removed from the voltage applied to the liquid crystal element 120.

From above, in the gradation levels when the gradation display is performed using the subfields, the DC components can be substantially or completely removed from the voltage applied to the liquid crystal element 120. In addition, in this embodiment, the writing polarity is reversed a plurality of times in each field, so that flicker is suppressed, thereby significantly reducing flicker.

As shown in FIGS. 8 and 9 according to the first comparative example, if polarity reversal is performed for example, in units of fields, depending on the gradation levels when the gradation display is performed using the subfields, a voltage application time for which the ON voltage is applied with the same polarity is lengthened, so that there is a technical problem in that the DC component is applied to the liquid crystal element 120 and burn-in of a screen occurs.

Specifically, assuming that the gradation level “9” is designated as the gradation level, this embodiment described above and the first comparative example are compared to each other. In this case, as shown in FIGS. 8 and 9, in the first comparative example, in the continuous two fields, in other words, in the odd number field and the even number field, the ON voltages with the negative polarity are applied to the subfields sf3, sf4, and sf7 of the odd number field and applied to the subfields sf3, sf4, and sf7 of the even number field. Therefore, in the first comparative example, in the continuous two fields, the voltage application time for which the ON voltage with the negative polarity is applied corresponds to 8 units of subfields. In addition, with regard to this unit, a voltage application time of a short subfield, for example, the voltage application time of the subfield sf1 is used as one unit. Furthermore, in the comparative example, in the continuous two fields, the ON voltage with the positive polarity is applied to the subfield sf2 of the odd number field and the subfield sf2 of the even number field. Therefore, in the comparative example, in the two continuous fields, the voltage application time for which the ON voltage with the positive polarity corresponds to two units of subfields. Therefore, in the comparative example, there is a technical problem in that, using a subtraction, a DC component corresponding to 6 units (“6=8−2” units) of subfields to which the ON voltages with the negative polarity are applied occurs.

Contrary to this, according to this embodiment, as shown in FIGS. 6 and 7, in the continuous two fields, the ON voltages with the negative polarity are applied to the subfields sf3, sf4, and sf7 of the odd number field and the subfield sf2 of the even number field. Accordingly, according to this embodiment, in the continuous two fields, the voltage application time for which the ON voltage with the negative polarity is applied corresponds to 6 units of subfields.

Furthermore, in this embodiment, in the continuous two fields, the ON voltages with the positive polarity are applied to the subfield sf2 of the odd number field and the subfields sf3, sf4, and sf7 of the even number field. Accordingly, in this embodiment, in the continuous two fields, the voltage application time for which the ON voltages with the positive polarity are applied corresponds to 6 units of subfields. Accordingly, in this embodiment, in the continuous two fields, the positive polarity voltage application time for which the ON voltage is applied with the positive voltage, and the negative polarity voltage application time for which the ON voltage is applied with the negative polarity become equal to each other, so that it is possible to make zero by subtracting the positive polarity voltage application time from the negative polarity voltage application time. As a result, the DC component caused by the ON voltage can be substantially or completely removed from the voltage applied to the liquid crystal element 120.

Substantially in the same manner, for all the gradation levels, when this embodiment and the first comparative example are compared to each other, as shown in FIG. 10, in the comparative example, burn-in of a screen occurs due to DC components at the gradation levels “1” to “6”, “8”, “9”, and “11” to “14”, that is, at 12 gradations from among all 16 gradation levels. Specifically, in the first comparative example, in a single field, at the gradation levels “1” to “6”, “8”, “9”, and “11” to “14” at which the positive polarity voltage application time for which the ON voltage is applied with the positive polarity (refer to “+” of ON periods in FIG. 10), and the negative polarity voltage application time for which the ON voltage is applied with the negative polarity (refer to “−” of ON periods in FIG. 10) are not equal to each other, “NG (No Good)” is determined, so that burn-in of the screen occurs due to the DC components.

Contrary to this, in this embodiment, at all gradation levels, in the continuous two fields, the positive polarity voltage application time for which the ON voltage is applied with the positive polarity and the negative polarity voltage application time for which the ON voltage is applied with the negative polarity are caused to be equal to each other, so that it is possible to substantially or completely eliminate deterioration of the liquid crystals 105 caused by the DC components.

As such, in the first embodiment, a single field is constituted by 8 subfields, and reversal of writing polarity is performed 4 times in the single field for every 2 subfields. As such, by performing reversal an even number of times in a single field, the polarity reversal can be made by the same subfields in the field next to the given field, so that DC components can be removed from the voltage applied to the liquid crystals 105. Therefore, assuming that X is a natural number equal to or greater than 2 and Y is an even number, a field is constituted by an X·Y number of subfields, and the potential of the data signal may be written in the pixel so that the reversal of writing polarity is performed Y times for every X subfields in the single field. In this case, the single field is divided in Y groups, and X subfields belong to each group. In addition, the polarity reversal is performed by switching the groups. Since the polarity reversal is performed Y times in the single field, it is possible to suppress flicker. Moreover, it is preferable that the lengths of the groups be the same.

### Second Embodiment

An electro-optical device according to a second embodiment is configured to be the same as the electro-optical device of the first embodiment except for reversal control of positive polarity writing and negative polarity writing.

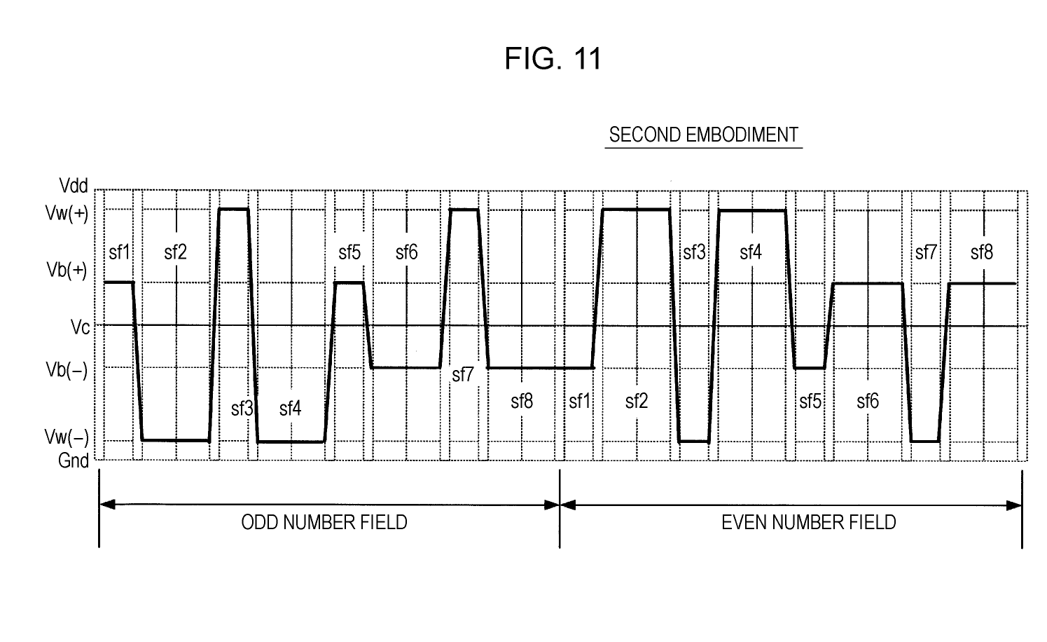

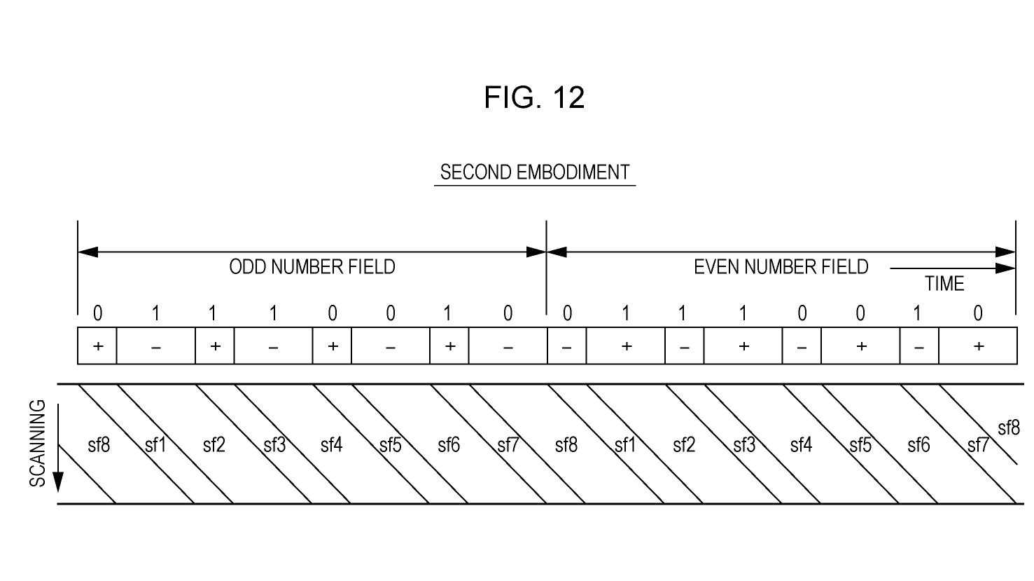

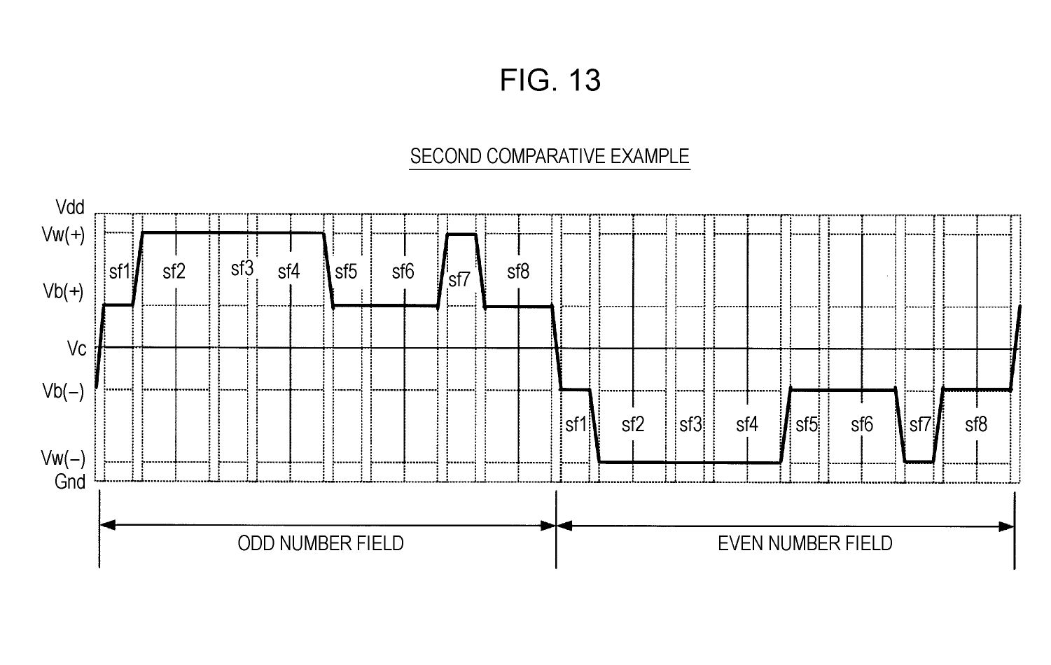

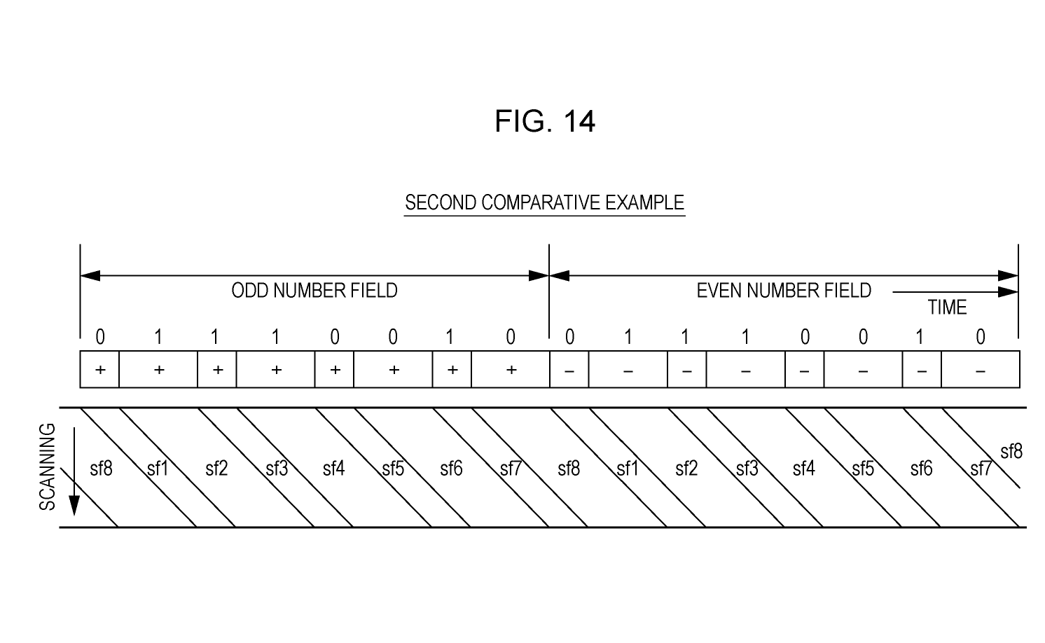

Referring to FIGS. 11 to 14, the polarity reversal control for switching any one of the positive polarity writing and the negative polarity writing according to the second embodiment to the other one will be described. Here, FIG. 10 is a schematic diagram showing a change in the voltage P(i,j) of the pixel electrode 118 in the liquid crystal element 120 in the i-th row and the j-th column according to the second embodiment. FIG. 12 is a schematic diagram showing polarities in the subfields according to the second embodiment, and a progress of selection of the 1-st to 2160-th rows of the scanning lines. In FIGS. 11 and 12, as the gradation level, the gradation level “9” is designated. In addition, in FIG. 12, “+” means the positive polarity writing, and “−” means the negative polarity writing. FIG. 13 is a schematic diagram showing a change in the voltage P(i,j) of the pixel electrode 118 in the liquid crystal element 120 in the i-th row and the j-th column according to a second comparative example. FIG. 14 is a schematic diagram showing polarities in the subfields according to the second comparative example, and a progress of selection of the 1-st to 2160-th rows of the scanning lines.

In the second embodiment, the polarity reversal is performed in units of a single subfield. In other words, the polarity reversal is performed 8 times in a field period. In addition, the polarities of the subfields sf1 to sf8 of the odd number field are caused to be different from the polarities of the subfields sf1 to sf8 of the even number field subsequent to the odd number field. Typically, as shown in FIG. 12, in a case where the positive polarity writing is performed in the subfields sf1, sf3, sf5, and sf7 of the odd number field, the negative polarity writing is performed in the subfields sf1, sf3, sf5, and sf7 of the even number field. In addition, in a case where the negative polarity writing is performed in the subfields sf2, sf4, sf6, and sf8 of the odd number field, the positive polarity writing is performed in the subfields sf2, sf4, sf6, and sf8 of the even number field.

Accordingly, as shown in FIG. 11, in the odd number field, the voltage P(i,j) becomes the voltage Vw(+) over a period corresponding to the subfields sf3 and sf7 to which the ON voltages are applied and the positive polarity writing is designated. On the other hand, to the subfields sf3 and sf7 in the even number field, the ON voltages are applied and the negative polarity writing is designated, so that the voltage P(i,j) becomes the voltage Vw(−) over a period corresponding to the subfields sf3 and sf7.

In addition, in the odd number field, the voltage P(i,j) becomes the voltage Vw(−) over a period corresponding to the subfields sf2 and sf4 to which the ON voltages are applied and the negative polarity writing is designated. On the other hand, to the subfields sf2 and sf4 in the even number field, the positive polarity writing is designated and the ON voltages are applied, so that the voltage P(i,j) becomes the voltage Vw(+) over the period corresponding to the subfields sf2 and sf4. Accordingly, in the two continuous fields, in other words, in the odd number field and the even number field, a positive polarity voltage application time for which the ON voltage is applied with the positive polarity, and a negative polarity voltage application time for which the ON voltage is applied with the negative polarity can be equal to each other, so that a DC component caused by the ON voltages can be substantially or completely removed from the voltage applied to the liquid crystal element 120. In particular, in the second embodiment, the number of reversals of the polarities in the fields is greater than that of the first embodiment, so that generation of flicker on the screen can be efficiently reduced. In addition, even regarding to a positive polarity voltage application time for which the OFF voltage is applied with the positive polarity, and a negative polarity voltage application time for which the OFF voltage is applied with the negative polarity according to the second embodiment, substantially the same operations as those of the case of the ON voltage are performed, so that the DC component caused by the OFF voltages can be substantially or completely removed from the voltage applied to the liquid crystal element 120.

As shown in FIGS. 13 and 14 according to the second comparative example, if the polarity reversal is performed in units of fields such as odd number fields or even number fields, there is a technical problem in that the units become longer than the case where subfields are units, and thus flicker may occur on the screen.

For this, according to the second embodiment, the polarity reversal is performed 8 times in a field period. In addition, the polarities of the subfields sf1 to sf8 of the odd number field are caused to be different from the polarities of the subfields of the even number field subsequent to the odd number field. As a result, according to the second embodiment, deterioration of the liquid crystals 105 due to the DC component can be substantially or completely eliminated, and generation of flicker on the screen can be efficiently reduced.

Here, in order that the polarity reversal is performed in units of subfields and the polarities are reversed in each subfield of the next field to a given field, the polarity reversal needs to be performed an even number of times in units of a single subfield. Therefore, it is preferable that a field is constituted by an even number of subfields.

### Third Embodiment

An electro-optical device according to the second embodiment is configured to be the same as the electro-optical device of the first embodiment except for reversal control of positive polarity writing and negative polarity writing.

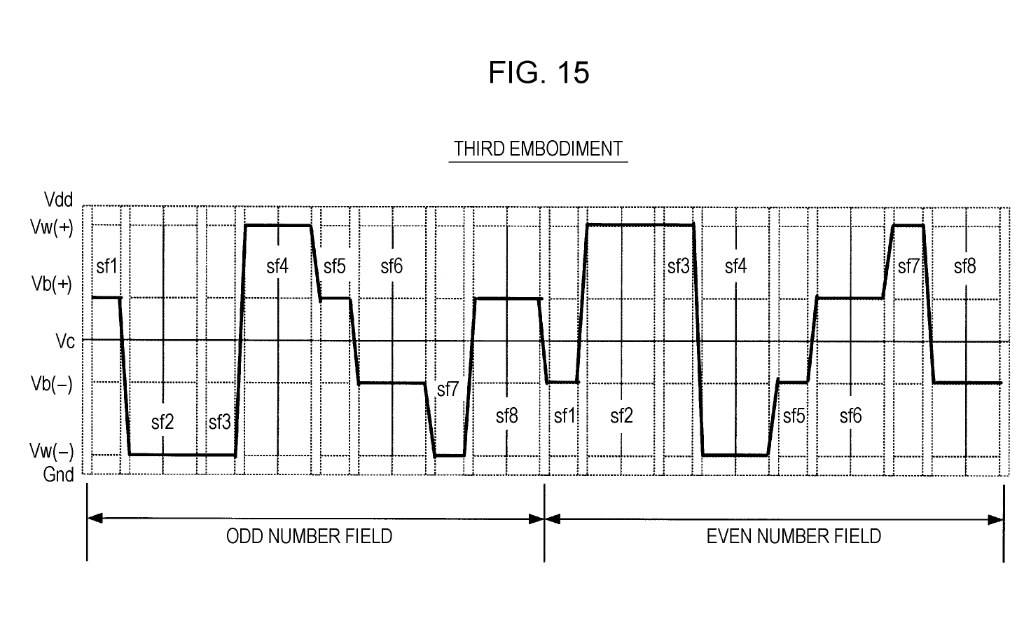

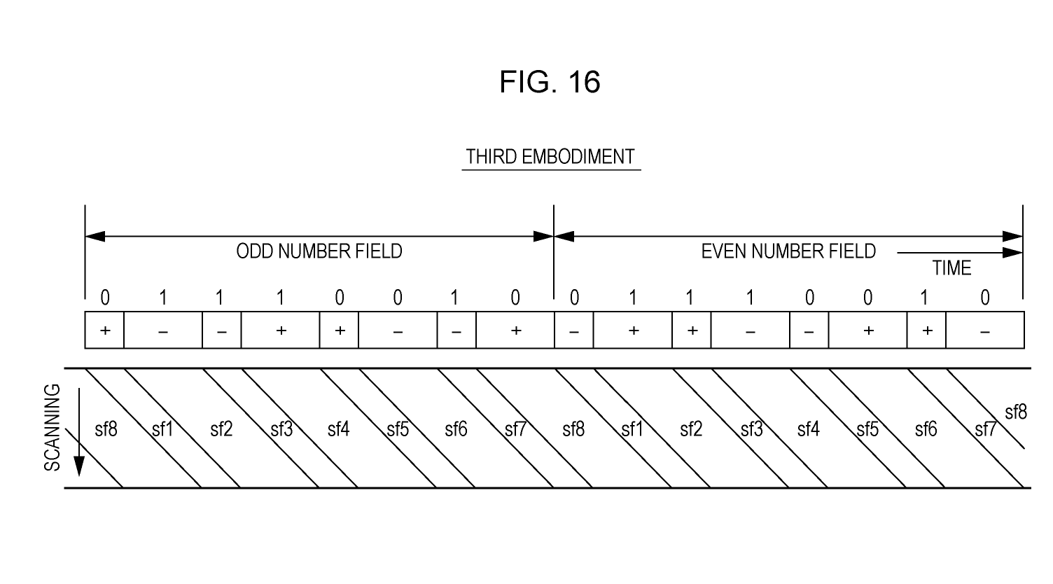

Referring to FIGS. 15 and 16, the polarity reversal control for switching any one of the positive polarity writing and the negative polarity writing according to a third embodiment to the other one will be described. Here, FIG. 15 is a schematic diagram showing a change in the voltage P(i,j) of the pixel electrode 118 in the liquid crystal element 120 in the i-th row and the j-th column according to the third embodiment. FIG. 16 is a schematic diagram showing polarities in the subfields according to the third embodiment, and a progress of selection of the 1-st to 2160-th rows of the scanning lines. In FIGS. 15 and 16, as the gradation level, the gradation level “9” is designated. In addition, in FIG. 16, “+” means the positive polarity writing, and “−” means the negative polarity writing.

In the third embodiment, on a time axis in a field, the polarity of the subfield sf1 positioned at the head and the polarity of the subfield sf8 positioned at the end are caused to be the same. In addition, in the remaining subfields excluding the subfields at the head and the end in the field, the polarity reversal is performed in units of 2 subfields. In addition, the polarities of the subfields sf1 to sf8 of the odd number field are caused to be different from the polarities of the subfields of the even number field subsequent to the odd number field. Typically, as shown in FIG. 16, when the positive polarity writing is performed in, in addition to the subfield sf1 at the head of the odd number field and the subfield sf8 at the end thereof, the subfields sf4 and sf6, the negative polarity writing is performed in the subfields sf1, sf8, sf4, and sf5 of the even number field. In addition, when the negative polarity writing is performed in the subfields sf2, sf3, sf6, and sf7 of the odd number field, the positive polarity writing is performed in the subfields sf2, sf3, sf6, and sf7 of the even number field.

Accordingly, as shown in FIG. 15, in the odd number field, the voltage P(i,j) becomes the voltage Vw(+) over a period corresponding to the subfield sf4 to which the ON voltage is applied and the positive polarity writing is designated. On the other hand, to the subfields sf3 and sf7 in the even number field, the ON voltages are applied and the negative polarity writing is designated, so that the voltage P(i,j) becomes the voltage Vw(−) over a period corresponding to the subfield sf4.

In addition, in the odd number field, the voltage P(i,j) becomes the voltage Vw(−) over a period corresponding to the subfields sf2, sf3, and sf7 to which the ON voltages are applied and the negative polarity writing is designated. On the other hand, to the subfields sf2, sf3, and sf7 in the even number field, the positive polarity writing is designated and the ON voltages are applied, so that the voltage P(i,j) becomes the voltage Vw(+) over the period corresponding to the subfields sf2, sf3, and sf7. Accordingly, in the two continuous fields, in other words, in the odd number field and the even number field, a positive polarity voltage application time for which the ON voltage is applied with the positive polarity, and a negative polarity voltage application time for which the ON voltage is applied with the negative polarity can be equal to each other, so that a DC component caused by the ON voltages can be substantially or completely removed from the voltage applied to the liquid crystal element 120. In particular, in the third embodiment, the polarity of the subfield sf1 positioned at the head in the field and the polarity of the subfield sf8 positioned at the end in the field are caused to be the same, and the polarities of the subfields sf1 to sf8 of the odd number field are caused to be different from the polarities of the subfields of the even number field subsequent to the odd number field, so that the reversal of polarities is reliably performed over continuous two fields. Accordingly, a state where a voltage with the same polarity is continuous applied during switching of fields can be appropriately avoided, so that time degradation of liquid crystal components can be efficiently suppressed.

In addition, according to the third embodiment, when the polarity reversal is performed in units of two subfields, that the same polarity is continuous over fields can be completely eliminated, so that the number of polarity reversals in two continuous fields can be increased, thereby more efficiently reducing the generation of flicker on the screen. In addition, even regarding to a positive polarity voltage application time for which the OFF voltage is applied with the positive polarity, and a negative polarity voltage application time for which the OFF voltage is applied with the negative polarity according to the third embodiment, substantially the same operations as those of the case of the ON voltage are performed, so that the DC component caused by the OFF voltages can be substantially or completely removed from the voltage applied to the liquid crystal element 120.

As a result, according to the third embodiment, time deterioration of the liquid crystals due to the DC component can be efficiently suppressed, and generation of flicker on the screen can be efficiently reduced.

In the third embodiment, the data signal is written in the pixels so that the writing polarities of the first subfield sf1 and the last subfield sf8 are caused to be the same, and in the 6 (X·Y) subfields constituting the subfields from the subfield sf2 next to the initial subfield to the subfield sf7 immediately before the last subfield, the reversal of the writing polarity is performed 3 times (Y times) for every 2 (X) subfields. In this case, an X·Y number of subfields (in this example, sf2 to sf7) excluding the first and the last subfields may be divided into Y groups, the polarity reversal may be performed in units of groups, and a group may be constituted by X subfields. Even in this case, time deterioration of the liquid crystals due to the DC component can be efficiently suppressed, and generation of flicker on the screen can be efficiently reduced.

### <Electronic Apparatus>

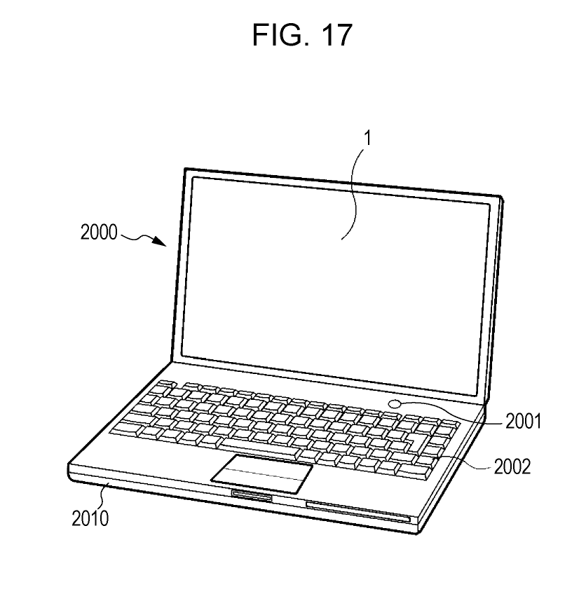

Next, an electronic apparatus to which the electro-optical device 1 according to the above-described embodiments and modified examples will be described. In FIG. 17, the configuration of a mobile type personal computer to which the electro-optical device 1 is applied is shown. A personal computer 2000 includes the electro-optical device 1 as a display unit and a main body portion 2010. The main body portion 2010 is provided with a power switch 2001 and a keyboard 2002.

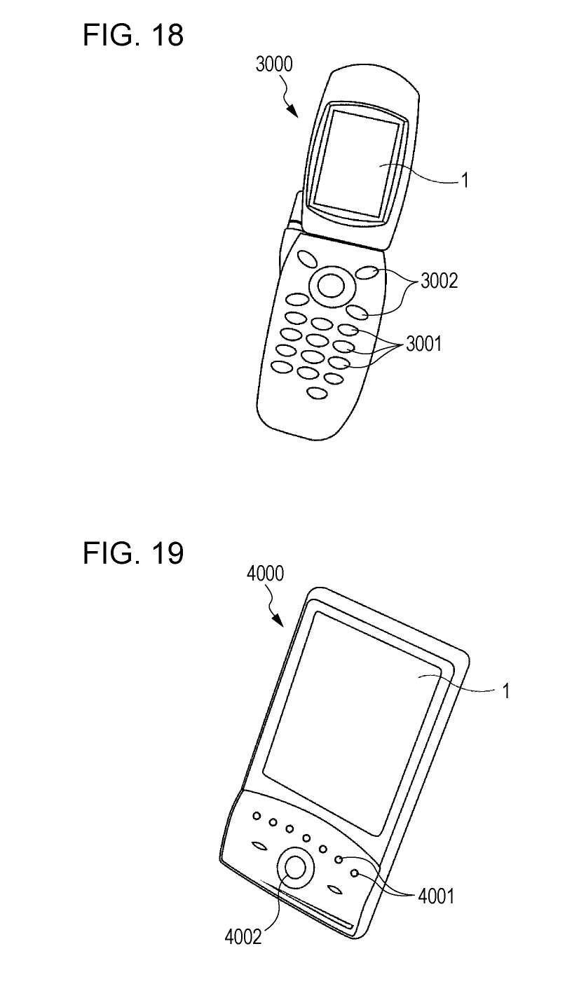

In FIG. 18, the configuration of a portable phone to which the electro-optical device 1 is applied is shown. A portable phone 3000 includes a plurality of operation buttons 3001, a scroll button 3002, and the electro-optical device 1 as a display unit. By operating the scroll button 3002, a screen displayed on the electro-optical device 1 is scrolled.

In FIG. 19, the configuration of an information portable terminal (PDA: Personal Digital Assistants) to which the electro-optical device 1 is applied is shown. An information portable terminal 4000 includes a plurality of operation buttons 4001, a power switch 4002, and the electro-optical device 1 as a display unit. When the power switch 4002 is operated, various kinds of information such as an address book or a schedule book are displayed on the electro-optical device 1.

Moreover, as the electronic apparatus to which the electro-optical device 1 is applied, besides those shown in FIGS. 17 to 19, a digital camera, a liquid crystal TV, viewfinder-type and direct-monitoring-type video tape recorders, a car navigation system, a pager, an electronic notebook, a word processor, a workstation, a video telephone, a POS terminal, devices with a touch panel, and the like may be employed. In addition, as the display units of such electronic apparatuses, the above-described electro-optical device 1 can be applied.

In addition, in the first to third embodiments described above, the liquid crystal display device which weights the subfields by causing the lengths of the subfield periods to be different is described; however, the invention can be applied to a liquid crystal display device which causes the lengths of subfields to be the same. In addition, in the first to third embodiments described above, the liquid crystal display in which a field has 8 subfields is described; however, the invention can be applied to a liquid crystal display device in which a field has N subfields (here, N is an integer equal to or greater than 2).

The invention is not limited to the above-described embodiments, and modifications can be appropriately made without departing from the spirit and scope of the invention that can be read from the claims and the entire specification. In addition, a driving method of an electro-optical device, an electro-optical device, and an electronic apparatus which follow the modifications are included in the technical scope of the invention.

### INDUSTRIAL APPLICABILITY

The invention can be used in a driving method of an electro-optical device, an electro-optical device, and an electronic apparatus.

### REFERENCE SIGNS LIST

1: ELECTRO-OPTICAL DEVICE

10: CONTROL CIRCUIT

20: MEMORY

30: CONVERSION TABLE

100: DISPLAY PANEL

105: LIQUID CRYSTAL

108: OPPOSITE ELECTRODE

110: PIXEL

112: SCANNING LINE

114: DATA LINE

116: TRANSISTOR

118: PIXEL ELECTRODE

120: LIQUID CRYSTAL CAPACITANCE

130: SCANNING LINE DRIVING CIRCUIT

140: DATA LINE DRIVING CIRCUIT

1. A driving method of an electro-optical device which includes a plurality of scanning lines, a plurality of data lines, a plurality of pixels provided to correspond to intersections of the scanning lines and the data lines, in which the plurality of pixels each has an electro-optical element including a pixel electrode, an opposite electrode, and an electro-optical material interposed between the pixel electrode and the opposite electrode and a switching element which is provided between the pixel electrode and the data line and is controlled to be in any one of states including an ON state and an OFF state by a scanning signal supplied via the scanning line, the driving method comprising:
causing a period needed for displaying a single screen to be a field period, when the field period is constituted by a plurality of subfield periods, sequentially supplying the scanning signals for causing the switching elements to be in the ON state to the plurality of scanning lines for each of the plurality of subfield periods, selecting the pixel for each of the scanning lines, and writing a signal potential corresponding to an image to be displayed on the pixel electrode of the selected pixel; and
in the writing of the signal potential, when it is assumed that a polarity of the signal potential with respect to a potential of the opposite electrode or a potential that is deviated from the potential of the opposite electrode by a predetermined potential is a writing polarity, reversing the writing polarity a plurality of times during the field period, and writing the signal potential so that the writing polarities of the plurality of subfield periods constituting a given field period are the reverse of the writing polarities of the plurality of subfields constituting the next field period.

2. The driving method according to claim 1, wherein, when it is assumed that X is a natural number equal to or greater than 2 and Y is an even number, the field period is constituted by an X·Y number of subfields, and the signal potential is written so that the reversal of the writing polarities is performed Y times for every X subfields during the field period.

3. The driving method according to claim 1, wherein the field period is constituted by an even number of subfield periods, and the signal potential is written so that the reversal of the writing polarities is performed for every subfield period.

4. The driving method according to claim 1, wherein, when it is assumed that X is a natural number equal to or greater than 2 and Y is an odd number, the field period is constituted by an X·Y+2 number of subfield periods, and the signal potential is written so that the writing polarities of a first subfield period in the field period and a last subfield period are caused to be the same, and the reversal of the writing polarities is performed Y times for every X subfield periods in an X·Y number of subfield periods from the first to immediately before the last.

5. An electro-optical device comprising:
a plurality of scanning lines;
a plurality of data lines;
a plurality of pixels provided to correspond to intersections of the scanning lines and the data lines, the plurality of pixels each having an electro-optical element including a pixel electrode, an opposite electrode, and an electro-optical material interposed between the pixel electrode and the opposite electrode and a switching element which is provided between the pixel electrode and the data line and is controlled to be in any one of states including an ON state and an OFF state by a scanning signal supplied via the scanning line;
scanning line driving means for causing a period needed for displaying a single screen to be a field period, when the field period is constituted by a plurality of subfield periods, sequentially supplying the scanning signals for causing the switching elements to be in the ON state to the plurality of scanning lines for each of the plurality of subfield periods, and selecting the pixel for each of the scanning lines; and
data line driving means for writing a signal potential corresponding to an image to be displayed on the pixel electrode of the pixel selected by the scanning line driving means via the plurality of data lines, and in the writing of the signal potential, when it is assumed that a polarity of the signal potential with respect to a potential of the opposite electrode or a potential that is deviated from the potential of the opposite electrode by a predetermined potential is a writing polarity, reversing the writing polarity a plurality of times during the field period, and writing the signal potential so that the writing polarities of the plurality of subfield periods constituting a given field period are the reverse of the writing polarities of the plurality of subfields constituting the next field period.

6. The electro-optical device according to claim 5,
wherein, when it is assumed that X is a natural number equal to or greater than 2 and Y is an even number, the field period is constituted by an X·Y number of subfields, and
the data line driving means writes the signal potential so that the reversal of the writing polarities is performed Y times for every X subfields during the field period.

7. The electro-optical device according to claim 5,
wherein the field period is constituted by an even number of subfield periods, and
the data line driving means writes the signal potential so that the reversal of the writing polarities is performed for every subfield period.

8. The electro-optical device according to claim 5,
wherein, when it is assumed that X is a natural number equal to or greater than 2 and Y is an odd number, the field period is constituted by an X·Y+2 number of subfield periods, and
the data line driving means writes the signal potential so that the writing polarities of a first subfield period in the field period and a last subfield period are caused to be the same, and the reversal of the writing polarities is performed Y times for every X subfield periods in an X·Y number of subfield periods from the first to immediately before the last.

9. An electronic apparatus comprising the electro-optical device according to claim 5.
